(19) United States
(12) Patent Application Publication
(10) Pub. No.: US 2022/0073213 A1
(43) Pub. Date: Mar. 10, 2022

(54) METHOD AND SYSTEM FOR CONTROLLING PHOTOELECTRIC POD

(71) Applicant: SICHUAN AOSSCI TECHNOLOGY CO.,LTD., Chengdu (CN)

(72) Inventors: Chao Wang, Chengdu (CN); Xiao Pu, Chengdu (CN); Songbai Xue, Chengdu (CN); Feng Xu, Chengdu (CN); Jin Wang, Chengdu (CN); Ruiqiang Xie, Chengdu (CN); Liang Chen, Chengdu (CN); Liang Guo, Chengdu (CN)

(73) Assignee: SICHUAN AOSSCI TECHNOLOGY CO.,LTD., Chengdu (CN)

(21) Appl. No.: 17/460,667

(22) Filed: Aug. 30, 2021

(30) Foreign Application Priority Data
Sep. 7, 2020 (CN) 202010927649.3

(51) Int. Cl. B64D 47/08; G06F 3/041; G06F 3/0487; G06F 3/038

(52) U.S. Cl. CPC B64D 47/08; G06F 3/038; G06F 3/0487; G06F 3/0416

(57) ABSTRACT

Disclosed are a method and a system for controlling a photoelectric pod. The method for controlling the photoelectric pod includes: selecting one or more of three control modes: a mouse control, a touch screen control, and a joystick control according to current situation of the photoelectric pod for control operations.

### CROSS-REFERENCE TO RELATED APPLICATIONS

This application claims priority to Chinese Patent Application No. 202010927649.3, filed on Sep. 7, 2020, the entire disclosure of which is incorporated herein by reference.

### TECHNICAL FIELD

The present disclosure relates to the technical field of unmanned aerial vehicle (UAV) control systems, in particular to a method and a system for controlling a photoelectric pod.

### BACKGROUND

In recent years, with the maturity of UAV system technology, UAVs equipped with photoelectric pods have become one of the most promising UAVs. The photoelectric pod mounted on the UAV can be used in anti-terrorism operations, patrol and reconnaissance, mineral detection, forest fire prevention and other fields. At the same time, higher requirements are put forward for the simplicity and reliability of the photoelectric pod operation mode during the mission.

The photoelectric pod operation is an important part of the UAV's combat missions such as patrol and reconnaissance. For a long time, in the task, the operator needs to manually switch the working mode of the photoelectric pod on the control interface frequently, which is inefficient and has a poor interactive experience.

### SUMMARY

In order to address the above problems, through long-term exploration attempts and many experiments and efforts, the inventor has continued to reform and innovate, and proposed a method and a system for controlling a photoelectric pod that can successfully complete flight tasks, improve task efficiency, and enhance the sense of interactive experience.

In order to achieve the above objective, the present disclosure provides a method for controlling a photoelectric pod, and the method is to select one or more of three control modes: mouse control, touch screen control, and joystick control to perform control operations according to the current situation of the photoelectric pod.

In order to achieve the above objective, the present disclosure provides a method for controlling a photoelectric pod, including:

selecting one or more of three control modes: a mouse control, a touch screen control, and a joystick control according to current situation of the photoelectric pod for control operations.

In an embodiment of the present disclosure, the method further includes:

receiving, by an information input and output module, touch screen control instructions, mouse control instructions, and joystick control instructions, and forwarding, by the information input and output module, the touch screen control instructions, the mouse control instructions, and the joystick control instructions to a data processing module according to timing sequence;

sending data processed by the data processing module to a flight control forwarding data module; and

forwarding, by the flight control forwarding data module, the data to the photoelectric pod to control the photoelectric pod.

In an embodiment of the present disclosure, received information is logically processed by the data processing module, and video data output by the data processing module is drawn and displayed by a display module.

In an embodiment of the present disclosure, a logical processing of the information by the data processing module includes switching a working mode of the photoelectric pod; protocol mapping between a flight controller and a touch screen, a mouse, and a joystick; and video decoding.

In an embodiment of the present disclosure, the mouse control includes:

single clicking a target on a real-time video screen sent back from the photoelectric pod by a left mouse button, and determining whether the operation of the photoelectric pod is to switch to a new tracking target or to enter a tracking mode and switch to the new tracking target according to whether a current mode is the tracking mode;

single clicking the target on the real-time video screen sent back from the photoelectric pod by a right mouse button, and determining whether the operation of the photoelectric pod is to switch to a new gaze target or to enter a gaze mode and switch to the new gaze target according to whether the current mode is the gaze mode; and

moving a mouse cursor to the real-time video screen sent back from the photoelectric pod, and zooming a currently locked target through the photoelectric pod according to forward and backward rolling of the mouse wheel.

In an embodiment of the present disclosure, the touch screen control includes:

single clicking the target on the real-time video screen sent back from the photoelectric pod through the touch screen, and determining whether the operation of the photoelectric pod is to switch to a new tracking target or to enter a tracking mode and switch to the new tracking target according to whether a current mode is the tracking mode;

long pressing the target on the real-time video screen sent back from the photoelectric pod through the touch screen, and determining whether the operation of the photoelectric pod is to switch to a new gaze target or to enter a gaze mode and switch to the new gaze target according to whether the current mode is the gaze mode; and

gesture operating the real-time video screen sent back from the photoelectric pod through the touch screen, and zooming the currently locked target through the photoelectric pod according to zoom of the gesture.

In an embodiment of the present disclosure, the joystick control includes:

using a built-in joystick of ground station hardware or an external joystick to realize pitch control, zoom, and switch mode operation of the photoelectric pod;

using left and right push rods to control azimuth of the photoelectric pod and using up and down push rods to control pitch of the photoelectric pod;

using a zoom knob or a wheel of the joystick to realize zoom function; and

using a button of the joystick to switch modes.

The present disclosure further provides a system for controlling a photoelectric pod, including:

a touch screen for real-time receiving and displaying a screen transmitted by the photoelectric pod, and controlling and manipulating the photoelectric pod through the touch screen;

a mouse for controlling and manipulating the photoelectric pod through displaying content of a display screen;

a joystick for controlling a state of the photoelectric pod by manually operating the joystick; and

a processor for receiving data transmitted by the photoelectric pod, and sending operation instructions of the touch screen, the mouse and the joystick to the photoelectric pod.

In an embodiment of the present disclosure, the touch screen includes:

a pointing tracking module for quickly switching to a tracking lock mode;

a pointing gaze module for quickly switching to a gaze mode; and

a gesture control module for quickly adjusting an angle of view of the photoelectric pod or electronic zoom.

In an embodiment of the present disclosure, the processor includes a data processing module, an information input and output module, and a flight control forwarding data module;

the data processing module is configured to logically process received data, the data processed by the data processing module is sent to the flight control forwarding data module; and

the flight control forwarding data module is configured to forward the data to the photoelectric pod to control the photoelectric pod.

Compared with the related art, the present disclosure has the following beneficial effects.

The present disclosure provides a method and a system for controlling a photoelectric pod. The system is deployed in the UAV ground command and control station, using a combination of software and hardware to effectively combine the three operation modes of manual joystick operation, mouse operation and touch screen operation. Therefore, the operation mode can be selected according to the on-site situation, and the photoelectric pod can be operated quickly and accurately with one hand. The patrol and investigation tasks can be completed simply and quickly, and the intelligence collection time can be reduced for the command center, which overcomes the problems of low efficiency and poor interactive experience caused by the inefficient manual operation that affects the operating speed, the mouse cannot adjust the viewing angle of the photoelectric pod, and the single joystick cannot switch the working mode of the photoelectric pod, target locking and other operations.

In the present disclosure, the switching mode of the photoelectric pod is to control the visual axis of the photoelectric pod through a physical joystick, and to manipulate the photoelectric pod through a combination of software such as a physical button, a wheel, and a touch screen. The present disclosure has reasonable design and is widely used in UAV ground control stations or UAV command and control systems, and plays a convenient and fast role when the UAV performs patrol and reconnaissance tasks that use photoelectric pods.

### BRIEF DESCRIPTION OF THE DRAWINGS

In order to explain the technical solutions of the embodiments of the present disclosure more clearly, the following will briefly introduce the drawings that need to be used in the embodiments. It should be understood that the following drawings only show some embodiments of the present disclosure, and therefore should not be regarded as limiting the scope. For those of ordinary skill in the art, other related drawings can be obtained from these drawings without creative work.

FIG. 1 is a schematic diagram of an operation process of a photoelectric pod of the present disclosure.

FIG. 2 is a system block diagram of the present disclosure.

### DETAILED DESCRIPTION OF THE EMBODIMENTS

In order to make the purpose, technical solutions and advantages of the present disclosure clearer, the technical solutions in the embodiments of the present disclosure will be described clearly and completely below. Obviously, the described embodiments are a part of the embodiments of the present disclosure, rather than all of the embodiments. Based on the embodiments in the present disclosure, all other embodiments obtained by those of ordinary skill in the art without creative work fall within the protection scope of the present disclosure. Therefore, the detailed description of the embodiments of the present disclosure provided below is not intended to limit the scope of the claimed present disclosure, but merely represents selected embodiments of the present disclosure.

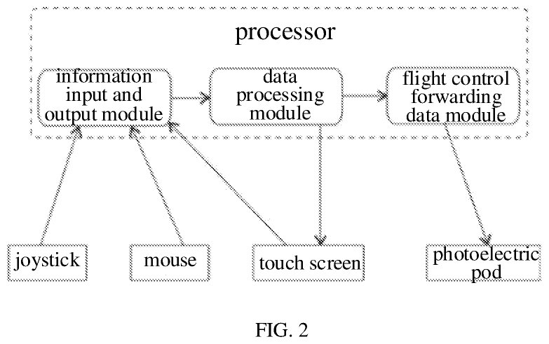

As shown in FIG. 2, the embodiment provides a system for controlling a photoelectric pod. The system includes:

a touch screen for real-time receiving and displaying a screen transmitted by the photoelectric pod, and controlling and manipulating the photoelectric pod through the touch screen;

a mouse for displaying content through a display screen to control and manipulate the photoelectric pod;

a joystick for controlling a state of the photoelectric pod by manually operating the joystick;

a processor for receiving data transmitted by the photoelectric pod, and sending operation instructions from the touch screen, the mouse and the joystick to the photoelectric pod.

The touch screen includes: a pointing tracking module for quickly switching to a tracking lock mode; a pointing gaze module for quickly switching to a gaze mode; and a gesture control module for quickly adjusting an angle of view of the photoelectric pod or electronic zoom.

The processor includes a data processing module, an information input and output module, and a flight control forwarding data module. The data processing module is configured to logically process received information; data processed by the data processing module is sent to the flight control forwarding data module; and the flight control forwarding data module is configured to forward the data to the photoelectric pod to control the photoelectric pod. The flight control forwarding data module is mainly configured to receive and forward the data and operation instructions of the photoelectric pod, the touch screen, the mouse and the joystick.

In the overall solution of the system, the information input and output module is for receiving touch screen events, mouse events, and joystick events, and forwarding the touch screen events, the mouse events, and the joystick events to the data processing module according to timing sequence. The data processed by the data processing module is sent to the flight control forwarding data module, and the flight control forwarding data module forwards the data to the photoelectric pod to achieve the purpose of controlling the photoelectric pod.

The data processing module is configured for logical processing of the data received by the information input and output module, such as switching a working mode of the photoelectric pod; protocol mapping between a flight controller and the touch screen, the mouse, and the joystick; and video decoding.

The display module is configured to display the video data output by the data processing module.

The flight control forwarding data module is configured to forward operation instructions. For example, when a target is locked or focused on, the joystick can be used to control the field of view of the photoelectric pod first. When the target enters the field of view, the target can be clicked on the display module to achieve a locked state of focusing on the target, and all operations can be repeated to complete the task.

The hardware settings in this embodiment are all purchased on the market, and the processor can be a computer or other device that can realize data processing and instruction sending.

The embodiment further provides a method for controlling a photoelectric pod, and the method is to reasonably select one or more of three control modes: mouse control, touch screen control, and joystick control to perform control operations according to the current situation of the photoelectric pod, so as to achieve the purpose of faster, more accurate and more efficient operation, and improve the interactive experience. The specific process is as follows.

The operation process of the photoelectric pod includes the processes of left and right mouse button clicks/touch screen click, mouse wheel, touch screen gesture, joystick operation (including joystick and built-in button wheel), or the like.

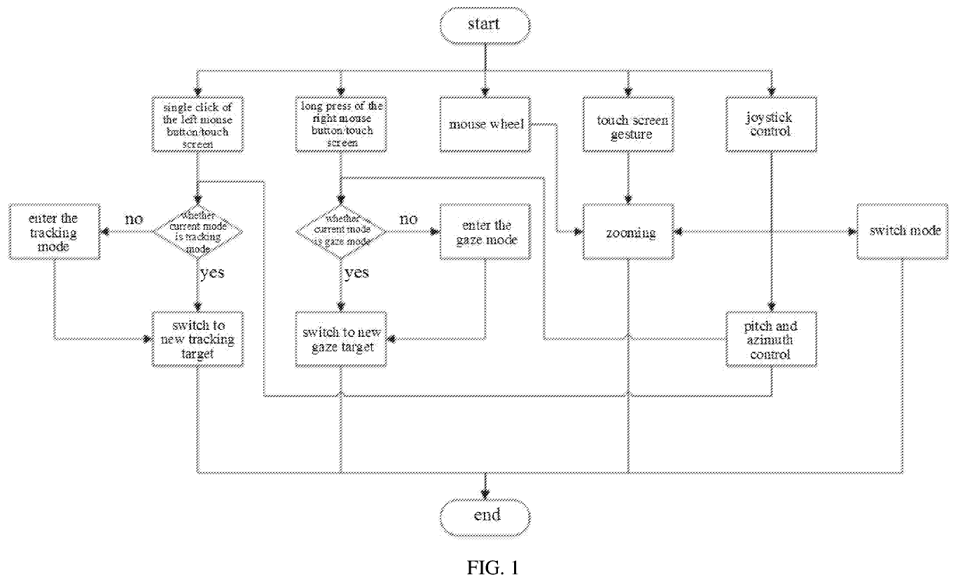

As shown in FIG. 1, the implementation process of photoelectric pod operation in the present disclosure is as follows.

Single click of the left mouse button/touch screen.

The left mouse button or the touch screen is configured to click a target on a real-time video screen sent back from the photoelectric pod, to determine whether the operation of the photoelectric pod is to switch to a new tracking target or to enter a tracking mode and switch to the new tracking target according to whether a current mode is the tracking mode.

Long press of the right mouse button/touch screen.

The right mouse button is configured to click or the touch screen is configured to long press the target on the real-time video screen sent back from the photoelectric pod, to determine whether the operation of the photoelectric pod is to switch to a new gaze target or to enter a gaze mode and switch to the new gaze target according to whether the current mode is the gaze mode.

The mouse wheel.

A mouse cursor is moved to the real-time video screen sent back from the photoelectric pod, and the photoelectric pod zooms a currently locked target according to forward and backward rolling of the mouse wheel.

The touch screen gesture.

The touch screen is configured to use a gesture (two-finger zoom gesture) on the real-time video screen sent back from the photoelectric pod, and the photoelectric pod zooms the currently locked target according to zoom of the gesture.

The joystick control.

The joystick control is configured to use a built-in joystick of ground station hardware or an external joystick to realize pitch control, zoom, and switch mode operation of the photoelectric pod, configured to use left and right push rods to control azimuth of the photoelectric pod and use up and down push rods to control pitch of the photoelectric pod, configured to use a zoom knob or a wheel of the joystick to realize zoom function, and configured to use a button of the joystick to switch modes.

The touch screen is for real-time receiving and displaying a screen transmitted by the photoelectric pod, and controlling and manipulating the photoelectric pod through the touch screen.

The mouse is for controlling and manipulating the photoelectric pod through the displayed content of a display screen.

The joystick is for controlling a state of the photoelectric pod by manually operating the joystick.

The processor is for receiving data transmitted by the photoelectric pod, and sending operation instructions from the touch screen, the mouse and the joystick to the photoelectric pod. The processor can also use an existing flight control system to complete the operation.

The system can at least realize functions including: pointing tracking, pointing gaze, manual control, manual zooming, etc.

The pointing tracking is to quickly switch to the tracking lock mode.

The pointing gaze is to quickly switch into the gaze mode.

The manual control is to control a yaw angle and a pitch angle of the photoelectric pod through a joystick in the work mode.

The manual zooming is to quickly adjust the angle of view of the photoelectric pod or electronic zoom.

The touch screen operation mode or execution and gestures in this embodiment can be adjusted adaptively according to the situation by those skilled in the art, and this embodiment only makes a specific mode to facilitate understanding.

The hardware devices and connection combinations in this embodiment can be adjusted according to actual practical and application scenarios by the technology in this field to adapt to different operating environments.

The related art is complicated to operate, and subsequent operations can only be performed after switching the mode each time through setting on the interface, which is low in efficiency. Through the technical solution of the present disclosure, real-time control operations on the screen can be realized, making the operations faster, more accurate, and more efficient.

The above are only some embodiments of the present disclosure. It should be pointed out that the above-mentioned embodiments should not be regarded as limiting the present disclosure, and the protection scope of the present disclosure should be subject to the scope defined by the claims. For those of ordinary skill in the art, without departing from the spirit and scope of the present disclosure, several improvements and modifications can be made, and these improvements and modifications should also be regarded as the protection scope of the present disclosure.

What is claimed is:

1. A method for controlling a photoelectric pod, comprising:
selecting one or more of three control modes: a mouse control, a touch screen control, and a joystick control according to current situation of the photoelectric pod for control operations.

2. The method of claim 1, further comprising:
receiving, by an information input and output module, touch screen control instructions, mouse control instructions, and joystick control instructions;
forwarding, by the information input and output module, the touch screen control instructions, the mouse control instructions, and the joystick control instructions to a data processing module according to timing sequence;
sending data processed by the data processing module to a flight control forwarding data module; and
forwarding, by the flight control forwarding data module, the data to the photoelectric pod to control the photoelectric pod.

3. The method of claim 2, wherein received information is logically processed by the data processing module, and video data output by the data processing module is drawn and displayed by a display module.

4. The method of claim 3, wherein a logical processing of the information by the data processing module comprises switching a working mode of the photoelectric pod; protocol mapping between a flight controller and a touch screen, a mouse, and a joystick; and video decoding.

5. The method of claim 1, wherein the mouse control comprises:
single clicking a target on a real-time video screen sent back from the photoelectric pod by a left mouse button, and determining whether the operation of the photoelectric pod is to switch to a new tracking target or to enter a tracking mode and switch to the new tracking target according to whether a current mode is the tracking mode;
single clicking the target on the real-time video screen sent back from the photoelectric pod by a right mouse button, and determining whether the operation of the photoelectric pod is to switch to a new gaze target or to enter a gaze mode and switch to the new gaze target according to whether the current mode is the gaze mode; and
moving a mouse cursor to the real-time video screen sent back from the photoelectric pod, and zooming a currently locked target through the photoelectric pod according to forward and backward rolling of the mouse wheel.

6. The method of claim 5, wherein the touch screen control comprises:
single clicking the target on the real-time video screen sent back from the photoelectric pod through the touch screen, and determining whether the operation of the photoelectric pod is to switch to a new tracking target or to enter a tracking mode and switch to the new tracking target according to whether a current mode is the tracking mode;
long pressing the target on the real-time video screen sent back from the photoelectric pod through the touch screen, and determining whether the operation of the photoelectric pod is to switch to a new gaze target or to enter a gaze mode and switch to the new gaze target according to whether the current mode is the gaze mode; and
gesture operating the real-time video screen sent back from the photoelectric pod through the touch screen, and zooming the currently locked target through the photoelectric pod according to zoom of the gesture.

7. The method of claim 6, wherein the joystick control comprises:
using a built-in joystick of ground station hardware or an external joystick to realize pitch control, zoom, and switch mode operation of the photoelectric pod;
using left and right push rods to control azimuth of the photoelectric pod and using up and down push rods to control pitch of the photoelectric pod;
using a zoom knob or a wheel of the joystick to realize zoom function; and
using a button of the joystick to switch modes.

8. A system for controlling a photoelectric pod, comprising:
a touch screen for real-time receiving and displaying a screen transmitted by the photoelectric pod, and controlling and manipulating the photoelectric pod through the touch screen;
a mouse for controlling and manipulating the photoelectric pod through displaying content of a display screen;
a joystick for controlling a state of the photoelectric pod by manually operating the joystick; and
a processor for receiving data transmitted by the photoelectric pod, and sending operation instructions of the touch screen, the mouse and the joystick to the photoelectric pod.

9. The system of claim 8, wherein the touch screen comprises:
a pointing tracking module for quickly switching to a tracking lock mode;
a pointing gaze module for quickly switching to a gaze mode; and
a gesture control module for quickly adjusting an angle of view of the photoelectric pod or electronic zoom.

10. The system of claim 9, wherein the processor comprises a data processing module, an information input and output module, and a flight control forwarding data module;
the data processing module is configured to logically process received data, the data processed by the data processing module is sent to the flight control forwarding data module; and
the flight control forwarding data module is configured to forward the data to the photoelectric pod to control the photoelectric pod.
